(19) United States
(12) Patent Application Publication
(10) Pub. No.: US 2013/0131303 A1
(43) Pub. Date: May 23, 2013

(54) MATERIAL FOR FIBER MANUFACTURING AND FIBER

(71) Applicant: SUMITOMO CHEMICAL COMPANY, LIMITED, Tokyo (JP)

(72) Inventors: Tomoya HOSODA, Tsukuba-shi (JP); Mitsuo MAEDA, Tsukuba-shi (JP); Satoshi OKAMOTO, Tsukuba-shi (JP)

(73) Assignee: SUMITOMO CHEMICAL COMPANY, LIMITED, Tokyo (JP)

(21) Appl. No.: 13/680,473

(22) Filed: Nov. 19, 2012

(30) Foreign Application Priority Data
Nov. 21, 2011 (JP) 2011-253882

(51) Int. Cl. C08G 63/60; B29B 7/00

(52) U.S. Cl. CPC C08G 63/605; B29B 7/002
USPC 528/302; 366/69; 366/75

(57) ABSTRACT

Disclosed is a material for fiber manufacturing obtained by melt kneading while degassing a liquid crystal polyester satisfying the following requirements (a) and (b):

(a) the flow starting temperature is equal to or greater than 280° C. and equal to or less than 360° C.; and
(b) the melting viscosity measured at 360° C. with conditions of a nozzle pore diameter of 0.5 mm and a shear velocity of 1000 s⁻¹ using a flow feature testing machine is equal to or less than 70 Pa·s.

### BACKGROUND OF THE INVENTION

1. Field of the Invention

The present invention relates to a material for fiber manufacturing and a fiber.

Priority is claimed on Japanese Patent Application No. 2011-253882, filed on Nov. 21, 2011, the content of which is incorporated herein by reference.

2. Description of Related Art

Liquid crystal polyester is widely used as a material for electronic parts and the like for having excellent low moisture absorption, heat resistance, thin formability, and the like. In recent years, by making use of such characteristics of liquid crystal polyester, fiber forming liquid crystal polyester has been considered.

In a case where liquid crystal polyester is fiber formed, generally, the liquid crystal polyester is melted before being extruded through pores and stretched. At this time, the lower the viscosity of the liquid crystal polyester in a melted state, the finer the fiber that can be obtained, and the more favorable the fiber formation.

Liquid crystal polyester of the related art could greatly increase in viscosity when in a melted state for a long time, and it could be difficult to spin fine fibers. However. in recent years, liquid crystal polyester that can reliably suppress an increase in the viscosity even in a melted state and that allows easy fiber formation while maintaining the characteristics has been proposed (Japanese Unexamined Patent Application, First Publication No. 2010-43380).

### SUMMARY OF THE INVENTION

However, fiber formed using liquid crystal polyester could have uneven strength, leaving room for improvement.

The present invention has been conceived in view of such circumstances, and an object thereof is to provide a material for fiber manufacturing which can reduce unevenness in the fiber strength. Further, another object thereof is to provide a fiber with unevenness in the fiber strength suppressed by using such a material.

As a result of the present inventors conducting various examinations into the problem described above, it was found that low molecular weight components such as monomers, dimers, and oligomers remaining in the liquid crystal polyester as a polymerization residue of the liquid crystal polyester were a cause of unevenness in strength. That is, it was found that in the formed fiber, there is unevenness in which the fiber strength at locations where there are no low molecular weight components is high while there is a large decrease in strength at locations where there are low molecular weight components.

Therefore, in order to solve the problem described above, the present invention provides a material for fiber manufacturing obtained by melt kneading while degassing a liquid crystal polyester satisfying the following requirements (a) and (b):

(a) the flow starting temperature is equal to or greater than 280° C. and equal to or less than 360° C.; and
(b) the melting viscosity measured at 360° C. with conditions of a nozzle pore diameter of 0.5 mm and a shear velocity of 1000 s⁻¹ using a flow feature testing machine is equal to or less than 70 Pa·s.

In the present invention, it is desirable that the liquid crystal polyester comprise the repeating units represented by the following Formulae (1), (2), and (3):

—O—Ar¹—CO—(1)

—CO—Ar²—CO— (2)

—X—Ar³—Y— (3)

wherein Ar¹ represents a phenylene group, a naphthylene group, or a biphenylylene group; Ar² and Ar³ each independently represent a phenylene group, a naphthylene group, a hiphenylylene group, or a group represented by the following Formula (4); X and Y each independently represent an oxygen atom or an imino group (—NH—); and hydrogen atoms in the group represented by Ar¹, Ar², or Ar³ may each be independently substituted by a halogen atom, an alkyl group with 1 to 10 carbon atoms, or an aryl group with 6 to 20 carbon atoms;

—Ar⁴—Z—Ar⁵— (4)

wherein Ar⁴ and Ar⁵ each independently represent a phenylene group or a naphthylene group; and Z represents an oxygen atom, a sulfur atom, a carbonyl group, a sulfonyl group, or an alkylidene group.

In the present invention, it is desirable that the liquid crystal polyester comprise a repeating unit represented by Formula (1) in which Ar¹ is a 1,4-phenylene group, a repeating unit represented by Formula (2) in which Ar² is a 1,4-phenylene group or a 1,3-phenylene group, and a repeating unit represented by Formula (3) in which Ar³ is a 4,4′-biphenylylene group.

In the present invention, it is desirable that the liquid crystal polyester have a content amount of a repeating unit including a 2,6-naphthylene group of equal to or greater than 40 mol % with respect to the total content amount of all repeating units.

In the present invention, it is desirable that the obtaining be under a vacuum condition of equal to or less than 0.04 MPa while being degassed and melt kneaded.

In the present invention, it is desirable that the obtaining use an extruder including vent portions at two or more locations while degassing and melt kneading from the vent portions at two or more locations.

In the present invention, it is desirable that the obtaining use an extruder including a kneading portion on the upstream side of a vent portion while degassing and melt kneading from the vent portion.

Further, the fiber of the present invention is obtained by spinning the material for fiber manufacturing described above.

That is, the present invention relates to the following.

[1] A material for fiber manufacturing obtained by melt kneading while degassing a liquid crystal polyester satisfying the following requirements (a) and (b):
(a) the flow starting temperature is equal to or greater than 280° C. and equal to or less than 360° C.; and
(b) the melting viscosity measured at 360° C. with conditions of a nozzle pore diameter of 0.5 mm and a shear velocity of 1000 s⁻¹ using a flow feature testing machine is equal to or less than 70 Pa·s.

[2] The material for fiber manufacturing according to [1], wherein the liquid crystal polyester comprises the repeating units represented by the following Formulae (1), (2), and (3):

—O—Ar¹—CO— (1)

—CO—Ar²—CO—and (2)

—X—Ar³—Y— (3)

wherein Ar¹ represents a phenylene group, a naphthylene group, or a biphenylylene group; Ar² and Ar³ each independently represent a phenylene group, a naphthylene group, a biphenylylene group, or a group represented by the following Formula (4); X and Y each independently represent an oxygen atom or an imino group (—NH—); and hydrogen atoms in the group represented by Ar¹, Ar², or Ar³ may each be independently substituted by a halogen atom, an alkyl group with 1 to 10 carbon atoms, or an aryl group with 6 to 20 carbon atoms;

—Ar⁴—Z—Ar⁵— (4)

wherein Ar⁴ and A⁵ each independently represent a phenylene group or a naphthylene group; and Z represents an oxygen atom, a sulfur atom, a carbonyl group, a sulfonyl group, or an alkylidene group.
[3] The material for fiber manufacturing according to [2], wherein the liquid crystal polyester comprises a repeating unit represented by Formula (1) in which Ar¹ is a 1,4-phenylene group, a repeating unit represented by Formula (2) in which Ar² is a 1,4-phenylene group or a 1,3-phenylene group, and a repeating unit represented by Formula (3) in which Ar³ is a 4,4′-biphenylylene group.
[4] The material for fiber manufacturing according to [2] or [3], wherein the liquid crystal polyester has a content amount of a repeating unit including a 2,6-naphthylene group of equal to or greater than 40 mol % with respect to the total content amount of all repeating units.
[5] The material for fiber manufacturing according to any one of [1] to [4] obtained by melt kneading while degassing the liquid crystal polyester under a vacuum condition of equal to or less than 0.04 MPa.
[6] The material for fiber manufacturing according to any one of [1] to [5] obtained by melt kneading while degassing the liquid crystal polyester using an extruder including vent portions at two or more locations from the vent portions at two or more locations.
[7] The material for fiber manufacturing according to any one of [1] to [6] obtained by melt kneading while degassing the liquid crystal polyester using an extruder including a kneading portion on the upstream side of a vent portion from the vent portion.
[8] A fiber obtained by spinning a material for fiber manufacturing according to any one of [1] to [7].
[9] A manufacturing method of a material for fiber manufacturing comprising a process of melt kneading while degassing a liquid crystal polyester satisfying the following requirements (a) and (b):
(a) the flow starting temperature is equal to or greater than 280° C. and equal to or less than 360° C.; and
(b) the melting viscosity measured at 360° C. with conditions of a nozzle pore diameter of 0.5 mm and a shear velocity of 1000 s⁻¹ using a flow feature testing machine is equal to or less than 70 Pa·s.

[10] The manufacturing method of the material for fiber manufacturing according to [9], wherein the liquid crystal polyester comprises repeating units represented by the following Formulae (1), (2), and (3):

—O—Ar¹—CO— (1)

—CO—Ar²—CO—and (2)

—X—Ar³—Y— (3)

wherein Ar¹ represents a phenylene group, a naphthylene group, or a biphenylylene group; Ar² and Ar³ each independently represent a phenylene group, a naphthylene group, a biphenylylene group, or a group represented by the following Formula (4); X and Y each independently represent an oxygen atom or an imino group (—NH—) and hydrogen atoms in the group represented by Ar¹, Ar², or Ar³ may each be independently substituted by a halogen atom, an alkyl group with 1 to 10 carbon atoms, or an aryl group with 6 to 20 carbon atoms;

—Ar⁴—Z—Ar⁵— (4)

wherein Ar⁴ and Ar⁵ each independently represent a phenylene group or a naphthylene group; and Z represents an oxygen atom, a sulfur atom, a carbonyl group, a sulfonyl group, or an alkylidene group.
[11] The manufacturing method of the material for fiber manufacturing according to [10], wherein the liquid crystal polyester comprises a repeating unit represented by Formula (1) in which Ar¹ is a 1,4-phenylene group, a repeating unit represented by Formula (2) in which Ar² is a 1,4-phenylene group or a 1,3-phenylene group, and a repeating unit represented by Formula (3) in which Ar^{a} is a 4,4′-biphenylylene group.
[12] The manufacturing method of the material for fiber manufacturing according to [10] or [11], wherein the liquid crystal polyester has a content amount of a repeating unit comprising a 2,6-naphthylene group of equal to or greater than 40 mol % with respect to the total content amount of all repeating units.
[13] The manufacturing method of the material for fiber manufacturing according to any one of [9] to [12] obtained by melt kneading while degassing the liquid crystal polyester under a vacuum condition of equal to or less than 0.04 MPa.
[14] The manufacturing method of the material for fiber manufacturing according to any one of [9] to [13] of melt kneading while degassing the liquid crystal polyester using an extruder comprising vent portions at two or more locations from the vent portions at two or more locations.
[15] The manufacturing method of the material for fiber manufacturing according to any one of [9] to [14] of melt kneading while degassing the liquid crystal polyester using an extruder including a kneading portion on the upstream side of a vent portion from the vent portion.

According to the present invention, a material for fiber manufacturing which can reduce the low molecular weight component amount by melt kneading while degassing and reduce unevenness in the fiber strength can be provided. Further, by using such a material, a fiber with unevenness in the fiber strength suppressed can be provided.

### DETAILED DESCRIPTION OF THE INVENTION

The material for fiber manufacturing of the present embodiment is obtained by melt kneading while degassing a liquid crystal polyester satisfying the following requirements (a) and (b).

(a) the flow starting temperature is equal to or greater than 280° C. and equal to or less than 360° C.
(b) the melting viscosity measured at 360° C. with conditions of a nozzle pore diameter of 0.5 mm and a shear velocity of 1000 s⁻¹ using a flow feature testing machine is equal to or less than 70 Pa·s.

Further, the fiber of the present embodiment is obtained by spinning the material for fiber manufacturing described above.

Here, the flow starting temperature is also referred to as the flow temperature, which is the temperature indicating the viscosity at 4800 Pa·s (48000 poises) when the liquid crystal polyester is melted by being heated at a speed of 4° C. per minute under a load of 9.8 MPa (100 kg/cm²) using a capillary rheometer and extruded from a nozzle with an inner diameter of 1 mm and a length of 10 mm, and is an indication of the molecular weight of the liquid crystal polyester (refer to Naoyuki Koide (ed.), “Liquid Crystal Polymer—Synthesis, Formation, Applications—”, CMC, Jun. 5, 1987, p. 95).

The molecular weight of the liquid crystal polyester in the present specification is represented by Mw, equal to or greater than 15000 and equal to or less than 30000 is preferably, and equal to or greater than 18000 and equal to or less than 30000 is more preferably. If the molecular weight (Mw) is equal to or greater than 15000, low molecular weight components tend to be reduced and the tensile strength lends to be high. lithe molecular weight is equal to or less than 30000, spinning can be performed stably.

Details of the present invention will be described below.

### Liquid Crystal Polyester

The liquid crystal polyester used in the material for fiber manufacturing of the present embodiment preferably exhibits liquid crystallinity in a melted state and melts at a temperature equal to or less than 450° C. Here, the liquid crystal polyester may be a liquid crystal polyester amide, a liquid crystal polyester ether, a liquid crystal polyester carbonate, or a liquid crystal polyester imide. The liquid crystal polyester is preferably a wholly aromatic liquid crystal polyester formed using only an aromatic compound as the raw material monomer.

Typical examples of the liquid crystal polyester include:

(I) A liquid crystal polyester in which at least one type of compound selected from a group including an aromatic diol, an aromatic hydroxy amine, and an aromatic diamine, an aromatic hydroxy carboxylic acid, and an aromatic dicarboxylic acid are polymerized (polycondensated);
(II) A liquid crystal polyester in which a plurality of types of aromatic hydroxy carboxylic acids are polymerized; (III) A liquid crystal polyester in which at least one type of compound selected from a group including an aromatic diol, an aromatic hydroxy amine, and an aromatic diamine, and an aromatic dicarboxylic acid are polymerized; and
(IV) A liquid crystal polyester in which a polyester such as polyethylene terephthalate and an aromatic hydroxy carboxylic acid are polymerized.

An aromatic hydroxy carboxylic acid is a compound in which two hydrogen atoms bonded to an aromatic compound are eachsubstituted from the aromatic compound by a hydroxyl group and a carboxyl group.

An aromatic dicarboxylic acid is a compound in which two hydrogen atoms bonded to an aromatic compound are each substituted from the aromatic compound by a carboxyl group.

An aromatic diol is a compound in which two hydrogen atoms bonded to an aromatic compound are each substituted from the aromatic compound by a hydroxyl group.

An aromatic hydroxyamine is a compound in which two hydrogen atoms bonded to an aromatic compound are each substituted from the aromatic compound by a hydroxyl group and an amino group.

An aromatic diamine is a compound in which two hydrogen atoms bonded to an aromatic compound are each substituted from the aromatic compound by an amino group.

Examples of aromatic compounds include benzene, naphthalene, biphenyl, and the like.

Here, for the aromatic hydroxy carboxylic acid, the aromatic dicarboxylic acid, the aromatic diol, the aromatic hydroxyamine, and the aromatic diamine, a polymerizable derivative may be used each independently instead of a portion or the entirety thereof.

Examples of polymerizable derivatives of a compound including a carboxylic group such as an aromatic hydroxy carboxylic acid or an aromatic dicarboxylic acid include an ester in which the carboxylic group is converted into an alkoxycarbonyl group or arm aryloxycarbonyl group, an acid halide in which the carboxyl group is converted into a haloformyl group, and an acid anhydride in which the carboxyl group is converted into an acyl oxycarbonyl group.

Examples of polymerizable derivatives of a compound including a hydroxyl group such as an aromatic hydroxy carboxylic acid, an aromatic diol, and an aromatic hydroxyamine include an acyl compound in which the hydroxyl group is acylated and converted into an acyloxyl group.

Examples of polymerizable derivatives of a compound including an amino group such as an aromatic hydroxyamine and an aromatic diamine include an acyl compound in which the amino group is acylated and converted into an acylamino group.

The liquid crystal polyester preferably comprises the repeating unit represented by the following Formula (1) (hereinafter may be referred to as “Repeating Unit (1)”), and more preferably comprises Repeating Unit (1), the repeating unit represented by the following Formula (2) (hereinafter may be referred to as “Repeating Unit (2)”), and the repeating unit represented by the following Formula (3) (hereinafter may be referred to as “Repeating Unit (3)”).

—O—Ar¹—CO— (1)

—CO—Ar²—CO—and (2)

—X—Ar³—Y— (3)

In the formulae, Ar¹ represents a phenylene group, a naphthylene group, or a biphenylylene group. Ar² and Ar³ each independently represent a phenylene group, a naphthylene group, a biphenylylene group, or a group represented by the following Formula (4). X and Y each independently represent an oxygen atom or an imino group (—NH—). hydrogen atoms in the group represented by Ar¹, Ar², or Ar³ may each be independently substituted by a halogen atom, an alkyl group with 1 to 10 carbon atoms, or an aryl group with 6 to 20 carbon atoms.

—Ar⁴—Z—Ar⁵— (4)

Ar⁴ and Ar⁵ each independently represent a phenylene group or a naphthylene group. Z represents an oxygen atom, a sulfur atom, a carbonyl group, a sulfonyl group, or an alkylidene group.

Examples of the halogen atom include a fluorine atom, a chlorine atom, a bromine atom, and an iodine atom.

Examples of the alkyl group preferably have 1 to 10 carbon atoms, and include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group, and an n-decyl group.

Examples of the aryl group preferably have 6 to 20 carbon atoms, and include a phenyl group, an o-tolyl group, an m-tolyl group, a p-tolyl group, a 1-naphthyl group, and a 2-naphthyl group.

In a case where the hydrogen atoms in the groups described above represented by Ar¹, Ar², or Ar³ are substituted by such groups, the number thereof for each of the groups described above represented by Ar¹, Ar², or Ar³ is each independently two or fewer and preferably one or fewer.

Examples of the alkylidene group described above preferably have 1 to 10 carbon atoms, and include a methylene group, an ethylidene group, an isopropylidene group, an n-butylidene group, and a 2-ethyl hexylidene group.

Repeating Unit (1) is a repeating unit derived from a predetermined aromatic hydroxy carboxylic acid. Repeating Unit (1) in which Ar¹ is a p-phenylene group (a repeating unit derived from a p-hydroxy benzoic acid) and Repeating Unit (1) in which Ar¹ is a 2,6-naphthylene group (a repeating unit derived from a 6-hydroxy-2-naphthoic acid) are preferable.

Repeating Unit (2) is a repeating unit derived from a predetermined aromatic dicarboxylic acid. Repeating Unit (2) in which Ar² is a p-phenylene group (a repeating unit derived from a terephthalic acid), Repeating Unit (2) in which Ar² is an m-phenylene group (a repeating unit derived from an isophthalic acid), Repeating Unit (2) in which Ar² is a 2,6-naphthylene group (a repeating unit derived from a 2,6-naphthalene dicarboxylic acid), and Repeating Unit (2) in which Ar² is a diphenyl ether-4,4′-diyl group (a repeating unit derived from a diphenyl ether-4,4′-dicarboxylic acid) are preferable.

Repeating Unit (3) is a repeating unit derived from a predetermined aromatic diol, aromatic hydroxylamine, or aromatic diamine. Repeating Unit (3) in which Ar³ is a p-phenylene group (a repeating unit derived from a hydroquinone, a p-aminophenol, or a p-phenylenediamine) and Repeating Unit (3) in which Ar³ is a 4,4′- biphenylylene group (a repeating unit derived from a 4,4′-dihydroxy biphenyl, a 4-amino-4′-hydroxy biphenyl, or a 4,4′-diaminobiphenyl) are preferable.

The content amount of Repeating Unit (1) with respect to the total amount of all repeating units (a sum value of the substance equivalent amount (mol) of each repeating unit found by dividing the mass of each repeating unit configuring the liquid crystal polyester by the formula weight of each repeating unit) is normally equal to or greater than 30 mol %, preferably equal to or greater than 30 mol % and equal to or less than 80 mol %, more preferably equal to or greater than 40 mol % and equal to or less than 70 mol %, and still more preferably equal to or greater than 45 mol % and equal to or less than 65 mol %.

The content amount of Repeating Unit (2) with respect to the total amount of all repeating units is normally equal to or less than 35 mol %, preferably equal to or greater than 10 mol % and equal to or less than 35 mol %, more preferably equal to or greater than 15 mol % and equal to or less than 30 mol %, and still more preferably equal to or greater than 17.5 mol % and equal to or less than 27.5 mol %.

The content amount of Repeating Unit (3) with respect to the total amount of all repeating units is normally equal to or less than 35 mol %, preferably equal to or greater than 10 mol % and equal to or less than 35 mol %, more preferably equal to or greater than 15 mol % and equal to or less than 30 mol %, and still more preferably equal to or greater than 17.5 mol % and equal to or less than 27.5 mol %.

A liquid crystal polyester having such a predetermined repeating unit composition has excellent heat resistance, formability, and balance. While the greater the content amount of Repeating Unit (1), the more easily the melt fluidity, the heat resistance, and strength and hardness improve, if the content amount is too high, the melting temperature and the melting viscosity tend to increase, and the temperature required for formation tends to increase.

Here, the content amount of Repeating Unit (2) and the content amount of Repeating Unit (3) are essentially preferably the same. The ratio between the content amount of Repeating Unit (2) and the content amount of Repeating Unit (3) is represented by [content amount of Repeating Unit (2)/[content amount of Repeating Unit (3)] (mol/mol), and is normally 0.9/1 to 1/0.9, preferably 0.95/1 to 1/0.95, and more preferably 0.98/1 to 1/0.98.

Here, the liquid crystal polyester may comprise two or more types of Repeating Units (1) to (3), each independently. Further, while the liquid crystal polyester may comprise a repeating unit other than Repeating Units (1) to (3), the content amount thereof with respect to the total amount of all repeating units is normally equal to or less than 10 mol % and preferably equal to or less than 5 mol %.

The liquid crystal polyester preferably comprises Repeating Unit (3) in which X and Y are each oxygen atoms (comprises a repeating unit derived from a predetermined aromatic diol) so that the melting viscosity is decreased, and more preferably comprises Repeating Unit (3) in which X and Y are each only oxygen atoms.

Further, if the required constituent components of the liquid crystal polyester have Ar¹ of Repeating Unit (1) including a 1,4-phenylene group, Ar² of Repeating Unit (2) including either one of a 1,4-phenylene group and a 1,3-phenylene group, and Ar³ of Repeating Unit (3) including a 4,4′-biphenylylene group, the strength and elasticity of the obtained fiber is excellent.

Furthermore, if the liquid crystal polyester has a content amount of equal to or greater than 40 mol % of a repeating unit including a 2,6-naplithylene group with respect to the total content amount of all repeating units, the obtained fiber has excellent electrical properties (low dielectric loss tangent).

In such a case, Repeating Unit (1) in which Ar¹ is a 2,6-naphthylene group (a repeating unit derived from a 6-hydroxy-2-naphthoic acid) is preferable as the obtained fiber has excellent electrical properties (low dielectric loss tangent).

Further, Repeating Unit (2) in which Ar¹ is a 2,6-naphthylene group (a repeating unit derived from a 2,6-nathalene dicarboxylic acid) and Repeating Unit (2) in which Ar² is a 1,4-phenylene group (a repeating unit derived from a terephthalic acid) are preferable as the obtained fiber has excellent electrical properties (low dielectric loss tangent).

Further, Repeating Unit (3) in which Ar³ is a 1,4-phenylene group (a repeating unit derived from a hydroquinone) and Repeating Unit (3) in which Ar³ is a 4,4-biphenylylene group (a repeating unit derived from a 4,4′-dihydroxybiphenyl) are preferable as the obtained liber has excellent electrical properties (low dielectric loss tangent).

A typical example of a liquid crystal polyester with high heat resistance and melt tension

(i) preferably includes equal to or greater than 40 mol % and equal to or less than 74.8 mol % of Repeating Unit (1) in which Ar¹ is a 2,6-naphthylene group (a repeating unit derived from a 6-hydroxy-2-naphthoic acid) with respect to the total amount of all repeating units, more preferably includes equal to or greater than 40 mol % and equal to or less than 64.5 mol %, and still more preferably includes equal to or greater than 50 mol % and equal to or less than 58 mol %,
(ii) preferably includes equal to or greater than 12.5 mol % and equal to or less than 30 mol % of Repeating Unit (2) in which Ar² is a 2,6-naphthylene group (a repeating unit derived from a 2,6-nathalene dicarboxylic acid) with respect to the total amount of all repeating units, more preferably includes equal to or greater than 17.5 mol % and equal to or less than 30 mol %, and still more preferably includes equal to or greater than 20 mol % and equal to or less than 25 mol %,
(iii) preferably includes equal to or greater than 0.2 mol % and equal to or less than 15 mol % of Repeating Unit (2) in which Ar² is a 1,4-phenylene group (a repeating unit derived from a terephthalic acid) with respect to the total amount of all repeating units, more preferably includes equal to or greater than 0.5 mol % and equal to or less than 12 mol %, and still more preferably includes equal to or greater than 2 mol % and equal to or less than 10 mol %,
(iv) preferably includes equal to or greater than 12.5 mol % and equal to or less than 30 mol % of Repeating Unit (3) in which Ar³ is a 1,4-phenylene group (a repeating unit derived from a hydroquinone) with respect to the total amount of all repeating units, more preferably includes equal to or greater than 17.5 mol % and equal to or less than 30 mol %, and still more preferably includes equal to or greater than 20 mol % and equal to or less than 25 mol %, and
(v) In the total amount of all repeating units, the content of Repeating Unit (2) in which Ar² is a 2,6-naphthylene group with respect to the total content amount of Repeating Unit (2) in which Ar² is a 2,6-naphthylene group and Repeating Unit (2) in which Ar² is a 1,4-phenylene group is preferably equal to or greater than 0.5 mol-fold and more preferably equal to or greater than 0.6 mol-fold.

The liquid crystal polyester can be manufactured by polymerizing (polycondensating) so that the total amount of monomers including a 2,6 naphthylene group (the total amount of a 6-hydroxy-2-naphthoic acid, a 2,6-naphthalene dicarboxylic acid, and a 2,6-naphthalene diol) is equal to or greater than 40 mol % with respect to the total amount of all monomers.

The liquid crystal polyester is preferably manufactured by melt polymerizing the raw material monomers corresponding to the repeating units configuring the liquid crystal polyester and solid-state polymerizing the obtained polymer (hereinafter may be referred to as the “prepolymer”). In so doing, a high molecular weight liquid crystal polyester with high heat resistance and strength and hardness can be manufactured to have good operability. The melt polymerization may be performed with the presence of a catalyst, and examples of the catalyst include metallic compounds such as magnesium acetate, stannous acetate, tetrabutyl titanate, lead acetate, sodium acetate, potassium acetate, and antimony trioxide and nitrogen-containing heterocyclic compounds such as 4-(dimethylamino)pyridine and 1-methyl-imidazole, and a nitrogen-containing heterocyclic compound is preferably used.

The liquid crystal polyester described above used as the raw material of the material for fiber manufacturing normally has a flow starting temperature of equal to or greater than 280° C., preferably equal to or greater than 280° C. and equal to or less than 400° C., and more preferably equal to or greater than 280° C. and equal to or less than 360° C. While the higher the flow starting temperature, the more easily heat resistance and strength and hardness improve, if the flow starting temperature is too high, the melting temperature and the melting viscosity tend to increase, making fiber formation difficult.

Further, the liquid crystal polyester has a melting viscosity measured in conditions of a nozzle pore diameter of 0.5 mm and a shear velocity of 1000 using a flow feature testing machine at 360° C. of equal to or less than 70 Pa·s. If the melting viscosity is greater than 70 Pa·s, the strength of the obtained fiber tends to decrease, and it tends to be difficult to reduce the low molecular weight components.

The liquid crystal polyester preferably has a melting viscosity of equal to or less than 40 Pa·s with the conditions described above at 360° C., and more preferably has a melting viscosity of equal to or less than 20 Pa·s with the conditions described above at 360° C.

When the long-term heat stability of the liquid crystal polyester in the fiber formation is considered, the liquid crystal polyester preferably has a temperature at which the melting viscosity is equal to or less than 70 Pa·s measured with the conditions described above of 340° C., more preferably a temperature at which the melting viscosity is equal to or less than 40 Pa·s measured with the conditions described above of 340° C., and still more preferably a temperature at which the melting viscosity is equal to or less than 20 Pa·s measured with the conditions described above of 340° C.

Here, with the melting viscosity described above, there is substantially no difference between a value measured for a powder of the liquid crystal polyester described above as the raw material of the material for fiber manufacturing and a value measure for the material for fiber manufacturing which is in pellet form through melt kneading using an extruder as described later. Therefore, the material for fiber manufacturing in pellet form with which measuring is convenient may be measured. Material for Fiber Manufacturing

The material for fiber manufacturing of the present embodiment can be prepared by melt kneading the liquid crystal polyester described above using an extruder. After melt kneading, the liquid crystal polyester is preferably formed in a pellet form.

An extruder including a cylinder, one or more screws arranged within the cylinder, a supply opening at one or more locations provided on the cylinder, and a vent portion at one or more locations provided on the cylinder is preferably used. An extruder including a kneading portion on the downstream side of the supply opening (each on the downstream side of each supply opening in a case where a plurality of supply openings are provided) is preferably used. Here, a kneading portion refers to a portion provided on a portion of a screw for efficiently performing melt kneading. Examples of the kneading portion include kneading discs (right kneading disc, neutral kneading disc, right kneading disc), a mixing screw, and the like.

The material for fiber manufacturing of the present embodiment is obtained by removing remaining low molecular weight components from the melt kneading liquid crystal polyester and decreasing the content amount by connecting a decompression device at locations with the vent portion at one or more locations provided on the cylinder and degassing within the cylinder using the decompression device during melt kneading.

The obtained material for fiber manufacturing has a melting viscosity measured in conditions of a nozzle pore diameter of 0.5 mm and a shear velocity of 1000 s⁻¹ using a flow feature testing machine at 360° C. of equal to or less than 70 Pa·s. If the melting viscosity measured with the conditions described above at 360° C. is greater than 70 Pa·s, the low molecular weight compounds tend not to decrease.

From investigations by the present inventors, it has been found that if there are low molecular weight components remaining in the liquid crystal polyester used as the raw material of the material for fiber manufacturing, the low molecular weight components are vaporized during the melt kneading and during the manufacture of the fiber (during spinning), forming bubbles on the inside. In a case where compacts such as a plate or a case is formed using the liquid crystal polyester, since the size of the bubbles is sufficiently small with respect to the thickness of the compact, there is little influence on the strength even if there are bubbles. However, in a case where the fiber is spun using the liquid crystal polyester, the bubbles are too large to be ignored relative to the size of the cross-section of the fiber, and the fiber is more easily ruptured from the positions of the bubbles. Since such bubbles are present in certain parts of the obtained fiber, the obtained fiber has high strength where there are no bubbles and low strength where there are bubbles, causing unevenness in strength.

On the other hand, since the material for fiber manufacturing of the present embodiment is melt kneaded while being degassed, the low molecular weight components inside the liquid crystal polyester can be favorably reduced, and the bubbles caused by low molecular weight components described above tend not to be formed. Therefore, ruptures of the fiber caused by the bubbles tend not to occur, suppressing unevenness in strength.

In order to further reduce the low molecular-weight components remaining in the liquid crystal polyester, the liquid crystal polyester is preferably degassed in a vacuum condition of equal to or less than 0.04 MPa using a decompression device, more preferably to equal to or less than 0.03 MPa, and still more preferably to equal to or less than 0.02 MPa.

While the decompression device is not particularly limited, the decompression of the vent portion is normally performed using a pump, examples of which include a water seal type pump, a rotary pump, an oil-diffusion pump, and a turbo pump.

Here, in the manufacture of the material for fiber manufacturing, melt kneading is preferably performed while degassing from vent portions at two or more locations by using an extruder including vent portions at two or more locations and connecting a decompression device to the respective vent portions.

Further, melt kneading is preferably performed using an extruder including a kneading portion on the upstream side of the vent portion connected to a decompression device.

### Fiber and Fiber Cloth Comprising Liquid Crystal Polyester

Next, the fiber obtained by spinning the material for fiber manufacturing of the embodiment described above and a fiber cloth (bonded textile or the like) using the fiber will be described.

The fiber of the present embodiment is obtained by spinning the material for fiber manufacturing described above. The fiber can be obtained by fiber forming the material for fiber manufacturing using a known method, and for example, can be obtained by melt spinning the material for fiber manufacturing.

In a case where the material for fiber manufacturing is fiber formed through melt spinning, the material for fiber manufacturing is heated to a melted state, and by extruding the material for fiber manufacturing in the melted state through a predetermined nozzle and then cooling while stretching the material for fiber manufacturing to solidify the material for fiber manufacturing once again, a fiber in which the material for fiber manufacturing has been thinned can be obtained.

At this time, while a liquid crystal polyester fiber is obtained if the material for fiber manufacturing which is stretched by the melt spinning is wound as is or the like, a fiber cloth (bonded textile) comprising a liquid crystal polyester fiber can be obtained if the material for fiber manufacturing is deposited on a predetermined substrate or the like while moving a nozzle or the like before the material for fiber manufacturing completely solidifies.

Since such a liquid crystal polyester fiber can be obtained by spinning the material for fiber manufacturing of the present embodiment described above, the liquid crystal polyester fiber is able to have a small dielectric loss and high heat resistance.

Further, since the liquid crystal polyester that is the raw material of the material for fiber manufacturing has high heat stability in which the decrease in viscosity is small even in a melted state for an extended amount of time, since the fiber formation by the melt spinning described above is easy and a low viscosity can be maintained, the formation of fine fibers is also possible.

Therefore, the liquid crystal polyester fiber and fiber cloth (bonded textile) of the present embodiment are easily fiber formed, have fine fiber diameters, and further maintain excellent characteristics of the liquid polyester such as a low dielectric loss and high heat resistance, and can be applied to a variety of uses including electronic parts. According to the material for fiber manufacturing with the configuration described above, the low molecular weight components can be reduced by degassing during melt kneading, and the unevenness in the fiber strength can be reduced.

Further, according to the liquid crystal polyester fiber with the configuration described above, by using the material described above, a fiber with unevenness in the fiber strength suppressed is obtained.

### Examples

While the present invention will be described through examples below, the present invention is not limited to such examples.

### Melting Viscosity

The melting viscosity was measured for the obtained pellets with conditions of a nozzle pore diameter of 0.5 mm and a shear velocity of 1000 s⁻¹ using a flow feature testing machine (capirograph) 1B manufactured by Toyo Machine Mfg. Co., Ltd. with respect to each measurement temperature.

### Flow Starting Temperature

The flow starting temperature of the liquid crystal polyester as the raw material of the material for fiber manufacturing was measured using a flow feature evaluation device “Flow Tester CFT-500 Type” manufactured by Shimadzu Corporation. The temperature at which the melting viscosity is 4800 Pa·s (48000 poise) when approximately 2 g of a sample was filled into a capillary type rheometer on which a die with an inner diameter of 1 mm and a length of 10 min is attached and the liquid crystal polyester was extruded from a nozzle at a temperature rising speed of 4° C/minute under a load of 9.8 MPa (100 kgf/cm²) was taken as the flow starting temperature.

### Synthesis of Prepolymer

911 g of (6.6 mol) of p-hydroxy benzoic acid, 409 g (2.2 mol) of 4,4′-dihydroxybiphenyl, 91 g (0.55 mol) of isophthalic acid, 274 g (1.65 mol) of terephthalic acid, and 1235 g (12.1 mol) of acetic anhydride were added and agitated in a reactor including an agitation device, a torque meter, a nitrogen gas inlet tube, a thermometer, and a reflux condenser.

Next, after adding 0.17 g of 1-methylimidazole as a catalyst and sufficiently substituting the inside of the reactor with nitrogen gas, the temperature was raised under a stream of nitrogen gas to 150° C. over 15 minutes, and the mixture was refluxed for 1 hour with the temperature maintained.

Next, after adding 1.7 g of 1-methylimidazole, the temperature was raised to 320° C. over 2 hours and 50 minutes while distilling the acetic acid byproduct which is distilled and the unreacted acetic anhydride. The point at which a rise in the torque can be seen was taken as the end of the reaction and the contents were extracted to obtain a prepolymer powder (particle diameter of approximately 0.1 mm to approximately 1 mm). The flow starting temperature was 257° C.

### Synthesis Example 1

After the temperature of the obtained prepolymer powder was raised from 25° C. to 250° C. over 1 hour, the temperature was raised from 250° C. to 280° C. over 3 hours and 34 minutes. By then solid-state polymerizing the prepolymer powder while maintaining the prepolymer powder at 280° C. for 5 hours before further cooling, Liquid Crystal. Polyester (A)-1 in a powder form was obtained.

The flow starting temperature of Liquid Crystal Polyester (A)-1 was 330° C.

### Synthesis Example 2

After the temperature of the obtained prepolymer powder was raised from 25° C. to 250° C. over 1 hour, the temperature was raised from 250° C. to 270° C. over 2 hours and 23 minutes. By then solid-state polymerizing the prepolymer powder while maintaining the prepolymer powder at 270° C. for 5 hours before further cooling, Liquid Crystal Polyester (A)-2 in a powder form was obtained.

The flow starting temperature of Liquid Crystal. Polyester (A)-2 was 315° C.

### Synthesis Example 3

After the temperature of the obtained prepolymer powder was raised from 25° C. to 250° C. over 1 hour, the temperature was raised from 250° C. to 275° C. over 2 hours and 58 minutes. By then solid-state polymerizing the prepolymer powder while maintaining the prepolymer powder at 275° C. for 5 hours before further cooling, Liquid Crystal Polyester (A)-3 in a powder form was obtained.

The flow starting temperature of Liquid Crystal Polyester (A)-3 was 320° C.

### Synthesis Example 4

After the temperature of the obtained prepolymer powder was raised from 25° C. to 250° C. over 1 hour, the temperature was raised from 250° C. to 277° C. over 3 hours and 13 minutes. By then solid-state polymerizing the prepolymer powder while maintaining the prepolymer powder at 277° C. for 5 hours before further cooling, Liquid Crystal Polyester (A)-4 in a powder form was obtained.

The flow starting temperature of Liquid Crystal. Polyester (A)-4 was 325° C.

### Example 1

Liquid Crystal Polyester (A)-1 obtained in Synthesis Example 1 was melt kneaded using a biaxial extruder (PCM-30, manufactured by Ikegai Corp.) and granulation processed in a pellet form. Two vent portions were provided on the cylinder of the extruder used, a water seal type pump was connected to each vent portion, and Liquid Crystal Polyester (A)-1 was processed while being decompressed to 0.02 M Pa·using the water seal type pumps during the melt kneading.

The melting viscosity measured for the obtained pellets with the conditions described above was 35 Pa·s at 350° C. Due to the knowledge of the present inventors, it is known that there is no difference in the melting viscosity of the liquid crystal polyester between a value measured for the liquid crystal polyester before melt kneading and a value measured for the pellets after melt kneading. Generally, since the greater the temperature of the liquid crystal polyester, the lower the melting viscosity, if the melting viscosity of Liquid Crystal Polyester (A)-1 is measured at 360° C., a melting viscosity value that is lower than the measurement result described above of 35 Pa·s is obtained. That is, it can be seen that the melting viscosity of Liquid Crystal Polyester (A)-1 measured at 360° C. is equal to or less than 70 Pa·s.

Next, after passing a material melted using the multifilament spinning device “Polymer Mate V” manufactured by Chubu Chemical Machine Works, Inc., Ltd. through a filter (made of stainless steel), the material was discharged from a nozzle and melt spun at 350° C. A nozzle with a pore diameter of 0.3 mm and 24 pores was used, and the material was wound at a discharge rate of 25 g/minute and a spinning speed of 400 m/minute.

Sampling was performed for the obtained liquid crystal polyester fiber after 10 minutes, 30 minutes, and 1 hour from the start of the discharge of the liquid crystal polyester fiber, and each sampled fiber was wound on a metal bobbin and heated for 12 hours at 320° C. The tensile strength of each heated thread thus obtained (average value of 5 test pieces) was measured.

### Example 2

Liquid Crystal Polyester (A)-2 was made into pellets in a similar manner to Example 1 except that the degree of decompression during the melt kneading was 0.04 MPa.

The melting viscosity measured for the obtained pellets with the conditions described above was 15 Pa·s at 340° C. Generally, since the greater the temperature of the liquid crystal polyester, the lower the melting viscosity, if the melting viscosity of Liquid Crystal Polyester (A)-2 is measured at 360° C., a melting viscosity value that is lower than the measurement result described above of 15 Pa·s is obtained. That is, it can be seen that the melting viscosity of Liquid Crystal Polyester (A)-2 measured at 360° C. is equal to or less than 70 Pa·s.

Spinning was performed using the obtained pellets in a similar manner to Example 1.

### Example 3

Liquid Crystal Polyester (A)-3 was made into pellets in a similar manner to Example 1 except that the degree of decompression during the melt kneading was 0.01 MPa.

The melting viscosity measured for the obtained pellets with the conditions described above was 16 Pa·s at 350° C. Generally, since the greater the temperature of the liquid crystal polyester, the lower the melting viscosity, if the melting viscosity of Liquid Crystal Polyester (A)-3 is measured at 360° C., a melting viscosity value that is lower than the measurement result described above of 16 Pa·s is obtained. That is, it can be seen that the melting viscosity of Liquid Crystal Polyester (A)-3 measured at 360° C. is equal to or less than 70 Pa·s.

Spinning was performed using the obtained pellets in a similar manner to Example 1.

### Example 4

Liquid Crystal Polyester (A)-4 was made into pellets in a similar manner to Example 1 except that the degree of decompression during the melt kneading was 0.02 MPa.

The melting viscosity measured for the obtained pellets with the conditions described above was 25 Pa·s at 350° C. Generally, since the greater the temperature of the liquid crystal polyester, the lower the melting viscosity, if the melting viscosity of Liquid Crystal Polyester (A)-4 is measured at 360° C., a melting viscosity value that is lower than the measurement result described above of 25 Pa·s is obtained. That is, it can be seen that the melting viscosity of Liquid Crystal Polyester (A)-4 measured at 360° C. is equal to or less than 70 Pa·s.

Spinning was performed using the obtained pellets in a similar manner to Example 1.

### Comparative Example 1

Liquid Crystal Polyester (A)-1 was made into pellets in a similar manner to Example 1 except that there was no decompression during the melt kneading.

The melting viscosity measured for the obtained pellets with the conditions described above was 22 Pa·s at 320° C. Generally, since the greater the temperature of the liquid crystal polyester, the lower the melting viscosity, if the melting viscosity of Liquid Crystal Polyester (A)-1 is measured at 360° C., a melting viscosity value that is lower than the measurement result described above of 22 Pa·s is obtained. That is, it can be seen that the melting viscosity of Liquid Crystal Polyester (A)-1 measured at 360° C. is equal to or less than 70 Pa·s.

Spinning was performed using the obtained pellets in a similar manner to Example 1.

### Comparative Example 2

Liquid Crystal Polyester (A)-2 was made into pellets in a similar manner to Example 1 except that there was no decompression during the melt kneading.

The melting viscosity measured for the obtained pellets with the conditions described above was 15 Pa·s at 340° C. Generally, since the greater the temperature of the liquid crystal polyester, the lower the melting viscosity, if the melting viscosity of Liquid Crystal Polyester (A)-2 is measured at 360° C., a melting viscosity value that is lower than the measurement result described above of 15 Pa·s is obtained. That is, it can be seen that the melting viscosity of Liquid Crystal Polyester (A)-2 measured at 360° C. is equal to or less than 70 Pa·s.

Spinning was performed using the obtained pellets in a similar manner to Example 1.

### Comparative Example 3

Liquid Crystal Polyester (A)-3 was made into pellets in a similar manner to Example 1 except that there was no decompression during the melt kneading.

The melting viscosity measured for the obtained pellets with the conditions described above was 16 Pa·s at 350° C. Generally, since the greater the temperature of the liquid crystal polyester, the lower the melting viscosity, if the melting viscosity of Liquid Crystal Polyester (A)-3 is measured at 360° C., a melting viscosity value that is lower than the measurement result described above of 16 Pa·s is obtained. That is, it can he seen that the melting viscosity of Liquid Crystal Polyester (A)-3 measured at 360° C. is equal to or less than 70 Pa·s.

Spinning was performed using the obtained pellets in a similar manner to Example 1.

### Comparative Example 4

Liquid Crystal Polyester (A)-4 was made into pellets in a similar manner to Example 1 except that there was no decompression during the melt kneading.

The melting viscosity measured for the obtained pellets with the conditions described above was 25 Pa·s at 350° C. Generally, since the greater the temperature of the liquid crystal polyester, the lower the melting viscosity, if the melting viscosity of Liquid Crystal Polyester (A)-4 is measured at 360° C., a melting viscosity value that is louver than the measurement result described above of 25 Pa·s is obtained. That is, it can be seen that the melting viscosity of Liquid Crystal Polyester (A)-4 measured at 360° C. is equal to or less than 70 Pa·s.

Spinning was performed using the obtained pellets in a similar manner to Example 1.

The measurement results of the tensile strength and the distribution (square of a standard deviation) are shown in the following Table 1 for the examples and comparative examples.

TABLE 1

| | Tensile strength (cN/dtex), (n = 5 average value) | | | | | | | |
|---|---|---|---|---|---|---|---|---|
| | Example | Example | Example | Example | Comparative | Comparative | Comparative | Comparative |
| | 1 | 2 | 3 | 4 | Example 1 | Example 2 | Example 3 | Example 4 |
| 10 minutes | 28.0 | 27.5 | 27.1 | 27.6 | 28.0 | 26.5 | 21.1 | 22.4 |
| from start | | | | | | | | |
| of | | | | | | | | |
| discharge | | | | | | | | |
| 30 minutes | 27.5 | 27.0 | 28.0 | 27.8 | 22.1 | 19.0 | 27.3 | 27.1 |
| from start | | | | | | | | |
| of | | | | | | | | |
| discharge | | | | | | | | |
| 1 hour from | 26.0 | 27.4 | 27.7 | 28.1 | 19.6 | 23.4 | 17.9 | 21.7 |
| start of | | | | | | | | |
| discharge | | | | | | | | |
| Distribution | 0.72 | 0.05 | 0.14 | 0.04 | 12.40 | 9.47 | 15.23 | 5.75 |

First, as a result of the evaluation, for all of the examples and comparative examples, spinning was performed stably for one hour from the start of the discharge of the liquid crystal polyester fiber without the thread of the liquid crystal polyester fiber being broken.

Further, it was found that in terms of the tensile strength of the obtained fiber, the distributions of materials for fiber manufacturing obtained by melt kneading by decompression degassing (Examples 1 to 4) were smaller than for materials for fiber manufacturing obtained by melt kneading without degassing (Comparative Examples 1 to 4), and fibers with even strength were obtained.

From such results, the utility of the present invention was confirmed.

Since the liquid crystal polyester fiber of the present invention can be spun stably without being broken and has even strength, the liquid crystal polyester fiber can be favorably used in electronic parts, for example, or the like.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A material for fiber manufacturing obtained by melt kneading while degassing a liquid crystal polyester satisfying following requirements (a) and (b):
(a) a flow starting temperature is equal to or greater than 280° C. and equal to or less than 360°; and
(b) a melting viscosity measured at 360° C. with conditions of a nozzle pore diameter of 0.5 mm and a shear velocity of 1000 s⁻¹ using a flow feature testing machine is equal to or less than 70 Pa·s.

2. The material for fiber manufacturing according to claim 1, wherein the liquid crystal polyester comprises repeating units represented by the following Formulae (1), (2), and (3):
—O—Ar¹—CO— (1)
—CO—Ar²—CO— and (2)
—X—Ar³—Y— (3)
wherein Ar¹ represents a phenylene group, a naphthylene group, or a biphenylylene group; Ar² and Ar³ each independently represent a phenylene group, a naphthylene group, a biphenylylene group, or a group represented by the following Formula (4); X and Y each independently represent an oxygen atom or an imino group (—NH—) and hydrogen atoms in the group represented by Ar¹, A², or Ar³ may each be independently substituted by a halogen atom, an alkyl group with 1 to 10 carbon atoms, or an aryl group with 6 to 20 carbon atoms;
—Ar⁴—Z—Ar⁵— (4)
wherein Ar⁴ and Ar⁵ each independently represent a phenylene group or a naphthylene group; and Z represents an oxygen atom, a sulfur atom, a carbonyl group, a sulfonyl group, or an alkylidene group.

3. The material for fiber manufacturing according to claim 2, wherein the liquid crystal polyester comprises a repeating unit represented by Formula (1) in which Ar¹ is a 1,4-phenylene group, a repeating unit represented by Formula (2) in which Ar² is a 1,4-phenylene group or a 1,3-phenylene group, and a repeating unit represented by Formula (3) in which Ar³ is a 4,4′-biphenylylene group.

4. The material for fiber manufacturing according to claim 2, wherein the liquid crystal polyester has a content amount of a repeating unit comprising a 2,6-naphthylene group of equal to or greater than 40 mol % with respect to a total content amount of all repeating units.

5. The material for fiber manufacturing according to claim 1, obtained by melt kneading while degassing the liquid crystal polyester under a vacuum condition of equal to or less than 0.04 MPa.

6. The material for fiber manufacturing according to claim 1, obtained by melt kneading while degassing the liquid crystal polyester using an extruder including vent portions at two or more locations from the vent portions at two or more locations.

7. The material for fiber manufacturing according to claim 1, obtained by melt kneading while degassing the liquid crystal polyester using an extruder including a kneading portion on an upstream side of a vent portion from the vent portion.

8. A fiber obtained by spinning a material for fiber manufacturing according to claim 1.

9. A manufacturing method of a material for fiber manufacturing including a process of melt kneading while degassing a liquid crystal polyester satisfying following requirements (a) and (b):
(a) a flow starting temperature is equal to or greater than 280° C. and equal to or less than 360° C.; and
(b) a melting viscosity measured at 360° C. with conditions of a nozzle pore diameter of 0.5 mm and a shear velocity of 1000 s⁻¹ using a flow feature testing machine is equal to or less than 70 Pa·s.

10. The manufacturing method of the material for fiber manufacturing according to claim 9, wherein the liquid crystal polyester comprises repeating units represented by the following Formulae (1), (2), and (3):
—O—Ar¹—CO— (1)
—CO—Ar²—CO— and (2)
—X—Ar³—Y— (3)
wherein Ar¹ represents a phenylene group, a naphthylene group, or a biphenylylene group; Ar² and Ar³ each independently represent a phenylene group, a naphthylene group, a biphenylylene group, or a group represented by the following Formula (4); and X and Y each independently represent an oxygen atom or an imino group (—NH—); and hydrogen atoms in the group represented by Ar³, Ar², or Ar³ may each be independently substituted by a halogen atom, an alkyl group with 1 to 10 carbon atoms, or an aryl group with 6 to 20 carbon atoms;
—Ar⁴—Z—Ar⁵— (4)
wherein Ar⁴ and Ar⁵ each independently represent a phenylene group or a naphthylene group; and Z represents an oxygen atom, a sulfur atom, a carbonyl group, a sulfonyl group, or an alkylidene group.

11. The manufacturing method of the material for fiber manufacturing according to claim 10, wherein the liquid crystal polyester comprises a repeating unit represented by Formula (1) in which Ar¹ is a 1,4-phenylene group, a repeating unit represented by Formula (2) in which Ar² is a 1,4-phenylene group or a 1,3-phenylene group, and a repeating unit represented by Formula (3) in which Ar³ is a 4,4′-biphenylylene group.

12. The manufacturing method of the material for fiber manufacturing according to claim 10, wherein the liquid crystal polyester has a content amount of a repeating unit comprising a 2,6-naphthylene group of equal to or greater than 40 mol % with respect to a total content amount of all repeating units.

13. The manufacturing method of the material for fiber manufacturing according to claim 9, obtained by melt kneading while degassing the liquid crystal polyester under a vacuum condition of equal to or less than 0.04 MPa.

14. The manufacturing method of the material for fiber manufacturing according to claim 9, of melt kneading while degassing the liquid crystal polyester using an extruder including vent portions at two or more locations from the vent portions at two or more locations.

15. The manufacturing method of the material for fiber manufacturing according to claim 9, of melt kneading while degassing the liquid crystal polyester using an extruder including a kneading portion on an upstream side of a vent portion from the vent portion.
